(19) United States
(12) Patent Application Publication
(10) Pub. No.: US 2021/0404047 A1
(43) Pub. Date: Dec. 30, 2021

(54) CARBURIZER AND CARBURIZATION METHOD USING THE SAME

(71) Applicant: NIPPON STEEL CORPORATION, Chiyoda-ku, Tokyo (JP)

(72) Inventors: Hitoshi MUNEOKA, Chiyoda-ku, Tokyo (JP); Norifumi ASAHARA, Chiyoda-ku, Tokyo (JP); Motohiro SAKAMOTO, Chiyoda-ku, Tokyo (JP); Tsuyoshi YAMAZAKI, Chiyoda-ku, Tokyo (JP)

(21) Appl. No.: 17/293,053

(22) PCT Filed: Dec. 6, 2019
(86) PCT No.: PCT/JP2019/047930

§ 371 Date: May 12, 2021

(30) Foreign Application Priority Data
Dec. 7, 2018 (JP) 2018-230108

(51) Int. Cl. C23C 8/22

(52) U.S. Cl. CPC C23C 8/22

(57) ABSTRACT

A carburizer, which effects carburization with respect to molten iron accommodated in an electric furnace or a ladle, includes a mixture of quicklime and a carbon material having an ash content of from 5 mass % to 18 mass %, and satisfies the conditions 0.6≤(mc+Mc)/ms≤2.7 and 0.7≤(mc+Mc)/ma≤6.5. A method of carburization uses this carburizer. Here, mc represents the mass of CaO in the carbon material, ms represents the mass of SiO₂ in the carbon material, ma represents the mass of Al₂O₃ in the carbon material, and Mc represents the mass of the quicklime.

### TECHNICAL FIELD

The present disclosure relates to a carburizer for efficiently performing carburization in an electric furnace or a ladle, and a carburization method using the same.

### RELATED ART

Conventionally, cold iron sources such as iron scrap, cold pig iron, and direct reduction iron are melted and refined in an electric furnace to produce steel materials used for building materials and the like. While the main energy source of this electric furnace is arc heat, for the purposes of promoting melting and refining and saving on expensive electric energy, auxiliary heat sources such as oxygen gas (for oxidative melting of iron), gaseous fuel, liquid fuel, powdered coke are also used.

Further, addition of a solid carbon material to molten iron as a carburizer to carburize the molten iron, and combustion of the carbon in the molten iron with oxygen gas as an auxiliary heat source, is also practiced. As the carburizer, artificial graphite, earthy graphite, various cokes, anthracite, wood, and materials produced from these materials have been used. In addition, in a melt reduction method, while a large amount of coal is generally added together with iron ore and oxidizing gas to reduce the iron ore, auxiliary carburization can be performed to produce high carbon steel in a ladle.

As a carburizer and a carburization method therewith, Patent Document 1, for example, discloses a carburizer for iron manufacture and steel manufacture obtained by firing earthy graphite having an ash content of less than 12% by mass. Patent Document 2 discloses a carburization technique characterized by adding earthy graphite. Patent Document 3 discloses a carburizer obtained by dry distillation of coconut palm or oil palm coconut husks as an alternative to coke. Further, Patent Document 4 discloses a technique for adding a carbon source derived from biomass as a carburization technique during dephosphorization treatment.

When iron scrap is used as a cold iron source in an electric furnace, carbon injection and oxygen enrichment operations are generally performed, and the carburizer is supplied to the blow gas and blown into the molten iron. In contrast, if the carburizer can be fed in by free fall from above the furnace, equipment related to gas transfer can be omitted, and further, restrictions on the particle size and the like of the carburizer are relaxed, and the cost is reduced. In addition, when direct reduction iron is used as a cold iron source instead of iron scrap, and when low-grade direct reduction iron with a low metallization rate is used, a carbon source for reduction is also necessary in addition to the carbon source as a heat source, and a large amount of carburization is required. Further, in order to produce low-N high-grade steel, it is necessary to carburize in order to perform nitrogen removal at the time of decarburization, and if carburization can be performed inexpensively and efficiently, high-grade steel can be produced at low cost.

In general, if an inexpensive carbon material containing a large amount of ash can be used, costs can be suppressed; however, a high ash content in the carbon material is not preferable in many usage methods. It is generally known that the carburization rate becomes significantly lower when the ash content amount is high. Here, the carburization rate means the rate at which the carbon concentration in the molten iron rises in a state in which the carbon source has been added into the furnace. For example, in Patent Document 1, it is shown that while earthy graphite having an ash content of less than 12% by mass realizes a carburizing property (carburization rate) equivalent to that of artificial graphite, the carburization rate is significantly lowered with a carburizer having a higher ash content amount than this. Further, Patent Document 4 shows that the higher the ash content amount, the lower the carburization rate becomes, and the carburizer is given an ash content amount of 9% by mass or less. It is thought that the reason that the carburization rate decreases when the ash content amount is high is that a component produced from the ash coats the carbonaceous material.

Further, a carburizer in which an additive has been added to a carbon material, and a carburization method using the same, have also been proposed. For example, Patent Document 5 describes adding CaF₂ and MgO to powdered anthracite to form briquetted anthracite ingots. However, at present, owing to problems such as elution of fluorine from slag, a fluorine-less material is required as an auxiliary material, and use thereof is limited. Further, Patent Document 6 discloses a carburizer in which a carbon material is mixed with from 20% by mass to less than 80% by mass of CaO; however, since the proportion of CaO is large, the costs are increased. Further, Patent Document 7 discloses an adjustment method in which a carburizer is top-blown and added by adjusting the mass ratio of CaO/C to 18 or more during RH-type vacuum degassing treatment; however, this method also has the problem that the proportion of CaO is large, and moreover, the scope of increase in the carbon concentration in molten steel is in the range of from 0.005 to 0.010 mass %, which is significantly different from production of molten iron in a general electric furnace.

### PRIOR ART DOCUMENTS

### Patent Documents

Patent Document 1: Japanese Patent Application Laid-open No. S55-38975
Patent Document 2: Japanese Patent Application Laid-open No. H1-247527
Patent Document 3: Japanese Patent Application Laid-open No. 2009-46726
Patent Document 4: Japanese Patent Application Laid-open No. 2013-72111
Patent Document 5: Japanese Patent Application Laid-open No. 2004-76138
Patent Document 6: Japanese Patent Application Laid-open No. 2003-171713
Patent Document 7: Japanese Patent Application Laid-open No. 2013-36056
Patent Document 8: Japanese Patent Application Laid-open No. 2016-151036
Patent Document 9: Japanese Patent No. 5803824

### SUMMARY OF INVENTION

### Problem to be Solved by the Invention

If an inexpensive carbon material containing a large amount of ash is used as the carburizer under a condition of weak agitation intensity such as in an electric furnace, there is a possibility that the carburization rate will decrease, as described above. The inventors have discovered that under a condition of weak agitation intensity such as in an electric furnace, the carburization rate decreases even at a lower ash concentration than that shown in Patent Document 1, and that the influence of the ash concentration becomes remarkable at about 5% by mass or more. In contrast, if the efficiency (that is, the carburization rate) when using a carbon material having a high ash content could be increased beyond what is conventionally known, this would be preferable because it would mean that an inexpensive carbon material can be used with high efficiency. To this end, measures are necessary to promote carburization by removing the film that forms on the carbonaceous surface as a result of the ash content in the carbon material. In addition, when the carburizer is fed in by free fall, unlike powder supply by injection or bottom blowing, there is a risk that the carburization rate will decrease because the contact area between the molten iron and the carburizer decreases, and that the carburization rate will decrease because the carburizer may be incorporated into the slag or scattered before it melts.

The present disclosure has been made in view of such circumstances, and an object of the present invention is to provide a carburizer that is inexpensive and has excellent reaction efficiency, and a carburization method using the same.

### Means for Solving the Problem

As a result of dedicated research to solve the above problems, the present inventors have found that the influence of the ash film on the carbonaceous surface can be reduced by adding quicklime to the carbon material. Further, it was also found that the appropriate amount of quicklime varies depending on the amount of SiO₂ and Al₂O₃ contained in the ash content (also referred to as “ASH” in the present disclosure).

The gist of the present disclosure is as follows.

<1> A carburizer that effects carburization with respect to molten iron accommodated in an electric furnace or a ladle, the carburizer including a mixture of quicklime and a carbon material having an ash content of from 5 mass % to 18 mass %, and the carburizer satisfying conditions stipulated in the following Formula (1) and Formula (2):

0.6≤(mc+Mc)/ms≤2.7 Formula (1):

0.7≤(mc+Mc)/ma≤6.5 Formula (2):

in which, in Formula (1) and Formula (2), mc represents a mass of CaO in the carbon material, ms represents a mass of SiO₂ in the carbon material, ma represents a mass of Al₂O₃ in the carbon material, and Mc represents a mass of the quicklime.

<2> The carburizer recited in <1>, in which the mixture satisfies conditions stipulated in the following Formula (1A) and Formula (2A):

0.6≤(mc+Mc)/ms≤1.9 Formula (1A):

0.7≤(mc+Mc)/ma≤5.0. Formula (2A):

<3> A method of carburization using the carburizer recited in <1> or <2>, the method including, in the electric furnace or the ladle, performing carburization by adding the carburizer to a molten iron surface formed by blowing in a gas and agitating the molten iron.
<4> The method of carburization recited in <3>, in which the carburizer is added by being fed towards the molten iron surface from a lance.

### Effect of the Invention

According to the present disclosure, it is possible to provide a carburizer that is inexpensive and has excellent reaction efficiency, and a carburization method using the same.

### BRIEF EXPLANATION OF THE DRAWINGS

FIG. 1 is a diagram for explaining a process of feeding in a carburizer from above and carbonizing using an arc-type electric furnace.

FIG. 2 is a diagram showing relationships between a capacity coefficient and a ratio C/S between CaO and SiO₂ in the carburizer for each carbon material.

FIG. 3 is a diagram showing relationships between a capacity coefficient and a ratio C/A between CaO and Al₂O₃ in the carburizer for each carbon material.

FIG. 4 is a diagram showing the magnitude of the carbonization rate on a CaO—SiO₂—Al₂O₃ ternary phase diagram.

FIG. 5 is a diagram showing relationships between a capacity coefficient and a ratio C/S between CaO and SiO₂ in the carburizer at different agitation power densities.

FIG. 6 is a diagram showing relationships between a capacity coefficient and a ratio C/A between CaO and Al₂O₃ in the carburizer at different agitation power densities.

### BEST MODE FOR CARRYING OUT THE INVENTION

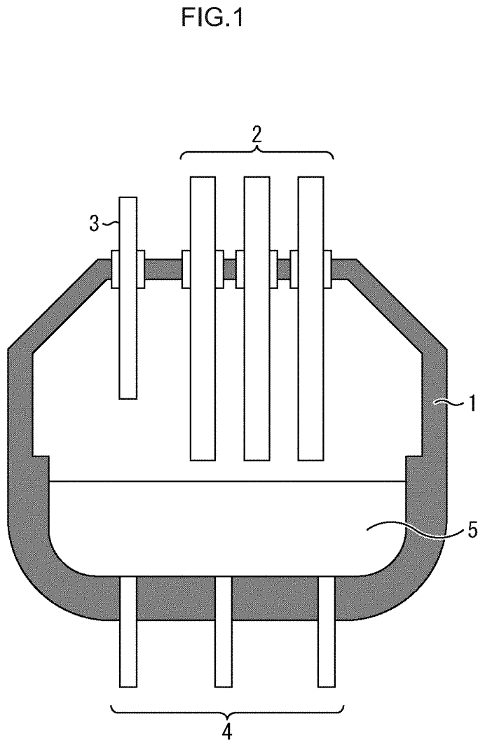

Hereinafter, embodiments of the present disclosure will be described with reference to FIG. 1.

As shown in FIG. 1, when carburizing molten iron, in an electric furnace 1 with a bottom blown tuyere 4, a carburizer is supplied from above molten iron 5 using a lance 3 that is different from electrodes 2. Agitation gas is input from bottom blown tuyere 4 to agitate the molten iron.

After feeding a carbon material into molten iron housed in an electric furnace or ladle, the temperature of the carbon material rises and while carbonaceous material melts from the surface of the carbon material, it is thought that ash that has remained unmolten forms an ash film on the surface of the carbonaceous material, impeding contact between the carbonaceous material and the molten iron, and has the effect of reducing the carburization rate. The main components of the ash content (ASH) in a carbon material are SiO₂ and Al₂O₃, and when both of these are combined, they account for 70% or more, and in many cases, about 90%, of the ash content in most coal types.

The present inventors have analyzed the ash film formed when this kind of a carbon material was added from above to molten iron, by means of electron microscopy and X-ray analysis. As a result, it was found that the composition of the ash film does not always match the ash composition in the carbon material. In particular, it was found that most of the SiO₂ in the ash was reduced, and most of the ash film became a compound having a high melting point and containing a large amount of Al₂O₃. Such compounds include, for example, Al₂O₃, CaO-6Al₂O₃, or spinel (MgO—Al₂O₃), each having a melting point of 1800° C. or higher, as the main component. Further, when a carburizer obtained by pre-adding quicklime powder to a carbon material and mixing the two together is used, CaO is added to the ash film and calcium silicate is formed, thereby suppressing SiO₂ reduction. As a result, it was found that the composition of the ash film changed in a direction approaching the composition expected from the analysis value of the carbon material and the amount of quicklime added, and in which the liquidus temperature decreases.

In addition, although sulfur is usually contained in naturally-derived carbon materials, it is known that sulfur in molten iron has the effect of inhibiting contact between carbon atoms and molten iron, thereby reducing the carburization rate. In contrast, as a result of experiments conducted by the present inventors, it has been demonstrated that when a carburizer in which quicklime has been added to a carbon material is used, the rate of increase in the sulfur concentration in the molten iron during carburizing is lower than in a case in which quicklime is not added. Further, this desulfurization behavior was the same not only in a vacuum furnace or a closed furnace but also in a normal atmospheric furnace as long as there was no active supply of an oxidizing gas such as oxygen gas or air. It is thought that this is because C and CaO in the carbon material are brought closer to each other and a reduction atmosphere is formed near the metal-slag interface as a result of adding and mixing quicklime powder in advance.

In this way, by using a carburizer in which quicklime has been mixed with a carbon material, an effect whereby the composition of the ash film formed on the surface of the molten iron or the carbon material is changed to prevent a decrease in the carburization rate, and an effect whereby the reaction boundary area is increased by local desulfurization of the surface of the molten iron, can be anticipated.

Next, various experiments were performed in order to optimize the mixing amount of quicklime. Table 1 below shows the types of carbon materials used in these experiments.

TABLE 1

| | | | Mixed Coal | | | |
|---|---|---|---|---|---|---|
| | Earthy | | (Coal B 60% + | | | |
| | Graphite | Coal A | Coal A 40%) | Coal B | Coal C | Coal D |
| Water content (%) | 0.21 | 5.89 | 2.81 | 0.76 | 7.10 | 1.89 |
| Ash content (ASH) (%) | 7.41 | 9.61 | 11.10 | 12.09 | 17.51 | 11.10 |
| Volatile content (%) | 0.30 | 2.86 | 20.91 | 32.95 | 4.65 | 8.20 |
| Fixed carbon content (%) | 92.08 | 81.64 | 65.18 | 54.20 | 70.74 | 78.81 |
| SiO₂ content (%) | 55.10 | 61.24 | 68.03 | 72.56 | 48.20 | 45.75 |
| Al₂O₃ content (%) | 34.28 | 28.74 | 19.94 | 14.08 | 40.85 | 15.55 |
| CaO content (%) | 0.58 | 0.9 | 1.30 | 1.56 | 3.8 | 22.27 |

The water content, ash content (ASH), volatile content, and fixed carbon content in the carbon materials shown in Table 1 (where % is mass %) are as defined by JIS M 8812: 2006, and specifically, are measured by the following methods.

Water content: weight loss when 5 g of a sample crushed to a particle size of 250 μm or less is dried at 107±2° C. until it reaches a constant weight.

Ash content (ASH): with the residue obtained by heating and incinerating 1 g of the sample at 815±10° C., the proportion (mass %) with respect to 1 g of the sample.

Volatile content: 1 g of a sample is placed in a platinum crucible with a lid, and the water content is removed from the weight loss when the sample is heated at 900±20° C. for 7 minutes with air cut off.

Fixed carbon content: fixed carbon content [mass %]=100−(water content [mass %]+ash content [mass %]+volatile content [mass %]).

Further, the composition of the ash in the carbon material is as defined by JIS M 8815: 1976, and is specifically measured by the following method. Further, SiO₂, Al₂O₃, and CaO are represented in mass % in the ash.

SiO₂: the sample is melted with sodium carbonate, the melted product is dissolved in hydrochloric acid, and treated with perchloric acid to dehydrate the silicic acid, and then filtered and the precipitate stored. The silicic acid in the filtrate is recovered, combined with the main precipitate, and ignited and incinerated to obtain silicic acid anhydride, hydrofluoric acid and sulfuric acid are added thereto to volatilize silicon dioxide, and the weight loss is determined.

Al₂O₃: the sample is decomposed with hydrofluoric acid, nitric acid and sulfuric acid, and dissolved with potassium pyrosulfate. The dissolved product is further dissolved in hydrochloric acid, the pH is adjusted with acetic acid and aqueous ammonia, and heavy metals are extracted and removed with DDTC and chloroform. A fixed amount of EDTA standard solution is added to this to form an EDTA-aluminum complex salt, and excess EDTA is back-titrated with a zinc standard solution.

CaO: a filtrate and a washing solution from quantifying silicon dioxide are collected, and this is combined with a solution obtained by melting the residue after quantifying silicon dioxide with sodium pyrosulfate and dissolving it in hydrochloric acid, and iron, aluminum, and the like are precipitated as hydroxides in aqueous ammonia and filtered. The pH of the solution is adjusted, magnesium hydroxide is precipitated, interference components are masked with potassium cyanide, and titration is performed with EDTA standard solution using an NN indicator.

The present inventors conducted experimentation in which they used a small melting furnace with a scale of 2 kg, controlled the bottom-blown flow rate of bottom-blown gas agitation, added a carburizer while maintaining a predetermined molten iron temperature, and measured the carburization rate after adding the carburizer. First, quicklime powder was mixed with the six types of carbon material shown in Table 1 to prepare powder-form carburizers. After this, electrolytic iron was melted in a small melting furnace, the carburizer was supplied to the molten iron surface from above, bottom-blown gas agitation was performed, sampling was performed at appropriate time intervals, and temporal variations in the carbon concentration in the molten iron were obtained. The addition ratio of quicklime powder (mass of quicklime powder/mass of carburizer) was altered within a range of from 0.05 to 0.25. The behavior of the carburization rate was assumed to be a primary reaction driven by the difference between the saturated C concentration and the C concentration in molten iron, and on the basis that the capacity coefficient K in the following Formula (3) is a constant value, the capacity coefficient K (1/s) was calculated. Here, Cₛ, Cₜ, and C₀ are each C concentrations (mass %) in molten iron, where Cₛ is the saturated C concentration, Cₜ is the C concentration at time t (s), and C₀ means the C concentration at time t=0.

ln((Cₛ−C₀)/(Cₛ−Cₜ))=K×t Formula (3):

The capacity coefficient K defined by Formula (3) is an index of the reaction efficiency of the carburizer, and it can be determined that the larger the capacity coefficient K, the faster the carburization rate of the carburizer and the more favorable the reaction efficiency.

The particle size of the carburizer was adjusted to the range of 1.0±0.4 mm by screening. Regarding the bottom-blown gas agitation, experimentation was performed in a range in which, in the agitation power density ε (kW/ton) calculated by the following Formula (4), ε=0.02 to 0.30. The range of this agitation power density was set as a range of practical values for an electric furnace or a ladle.

ε=371×Q×(T+273)/V×{ln(1+ρ×g×L/P)+1−(Tₙ+273)/(Tₙ+273)} Formula (4):

In Formula (4), Q: total flow rate of bottom-blown gas (Nm³/S), T: molten iron temperature (° C.), V: molten iron volume (m³), ρ: molten iron density (kg/m³), g: gravity acceleration (m/s²), L: floating height of in-blown gas (m), P: atmospheric pressure (Pa), and Tₙ: in-blown gas temperature (° C.). In the small melting furnace tests, L means the molten iron depth in the small melting furnace.

In the tests using this small melting furnace, the experimentation was carried out while maintaining the molten iron temperature T at 1400° C.±20° C. As discussed above, the main composition of the ash film when quicklime powder is not added is a composition containing a large amount of Al₂O₃ and having a high melting point, and the composition does not melt even at 1700° C. or 1750° C., which is the practical upper limit of the temperature normally used in an electric furnace. In the present disclosure, the ash film is controlled so as to have a composition of mainly CaO—SiO₂-Al₂O₃ by mixing quicklime powder with a carbon material; however, in these three components, the compositional range in which the liquidus temperature is 1350° C. or lower is extremely narrow, and since the ash content composition in the carbon material varies from particle to particle, it is difficult to stably control the amount of quicklime added such that the ash film can be melted owing to the composition.

Therefore, a temperature in the vicinity of 1400° C. was selected as a realistic temperature that can be stably applied, and evaluation was performed with 1400° C. as the basis. If the temperature is higher than this, the liquid phase will be reached at a broader compositional range, and the viscosity will decrease, and therefore, as long as the amount of quicklime added is in the range evaluated at 1400° C., this amount will be effective even at a molten iron temperature exceeding 1400° C. Under relatively high temperature conditions such as 1600° C., similar effects may be exhibited with a wider range of quicklime addition amounts; however, by adjusting the composition such that the effects are exhibited at 1400° C., the fluidity is increased and a remarkable reaction promotion effect can be anticipated. Realistically, the molten iron temperature is preferably 1750° C. or lower, and more preferably 1700° C. or lower, from the viewpoint of refractory material wear resistance. In addition, there may be a localized high temperature field such as an arc spot or an ignition point due to a top-blown oxygen lance. In principle, the temperature of the reaction part should be used as the molten iron temperature; however, since, in practice, there are problems with the measurability or the uniformity of temperature distribution, the average molten iron temperature as a whole may be used instead.

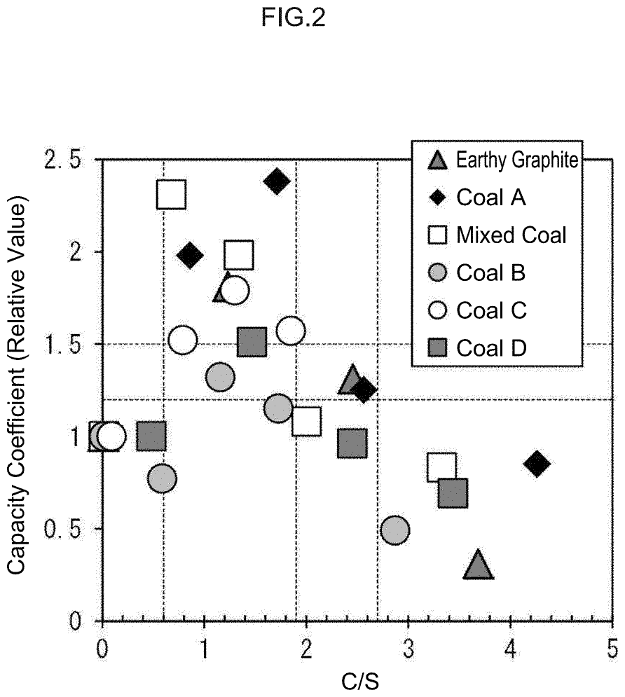

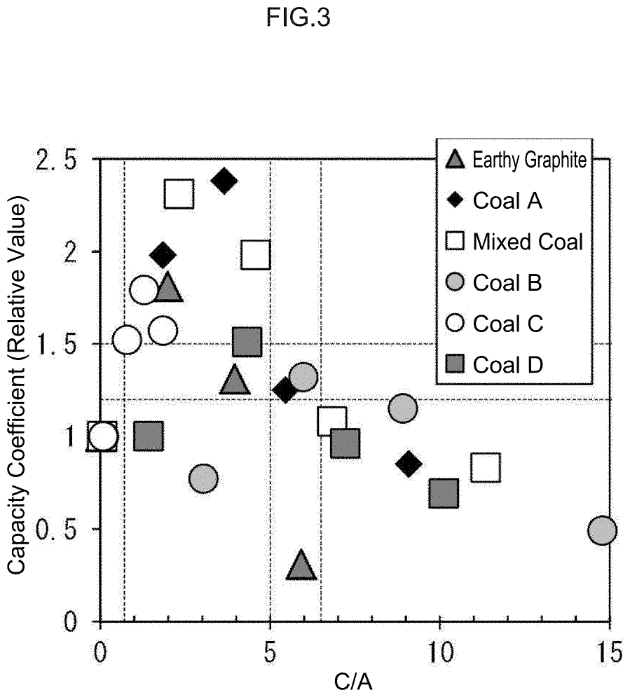

First, experimentation results when ε=0.08±0.01 kW/t are shown in FIGS. 2 and 3. Here, when the ratio ({mc+Mc}/M) of the sum of the mass (mc) of CaO and the mass (Mc) of quicklime in the ash contained in the carbon material to the mass (M) of the carburizer is C, the ratio (ms/M) of the mass (ms) of SiO₂ in the ash to the mass (M) of the carburizer is S, and the ratio (ma/M) of the mass (ma) of the Al₂O₃ in the ash to the mass (M) of the carburizer is A, C, S and A respectively represent the ratios of CaO, SiO₂, and Al₂O₃ contained in the carburizer. It should be noted that the ratio of each component in the ash contained in the carbon material is the product of the ratio of ash in the carbon material and the ratio of each component in the ash.

In FIG. 2, the horizontal axis represents the ratio C/S (=(mc+Mc)/ms), and in FIG. 3, the horizontal axis represents the ratio C/A (=(mc+Mc)/ma). In addition, the vertical axes both represent the relative value of the capacity coefficient (K), which is a ratio relative to the capacity coefficient (K0) when a carbon material to which quicklime powder has not been added is used; that is, K/K0.

In a case in which the relative value K/K0 of the capacity coefficient exceeds 1.2, it can be determined that the carburization rate is significantly improved even if experimental variations are subtracted. As shown in FIG. 2, in a case in which the ratio C/S is from 0.6 to 2.7, there were many examples in which the relative value K/K0 of the capacity coefficient was in excess of 1.2. Further, as shown in FIG. 3, in a case in which the ratio C/A is from 0.7 to 6.5, there were many examples in which the relative value K/K0 of the capacity coefficient was in excess of 1.2. Further, in a case in which the ratio C/S is from 0.6 to 1.9 and the ratio C/A is from 0.7 to 5.0, the relative value K/K0 of the capacity coefficient was in excess of 1.5 and it was confirmed that the carburization rate significantly improved. However, as shown in FIGS. 2 and 3, when considering only one or other of the ratio C/A and the ratio C/S, even within the above-described regions, there were also conditions under which the relative value K/K0 of the capacity coefficient was 1.2 or lower or 1.5 or lower. Further, in examples in which the ratio C/S is from 0.6 to 2.7 and the ratio C/A is from 0.7 to 6.5, the relative value K/K0 of the capacity coefficient exceeded 1.2.

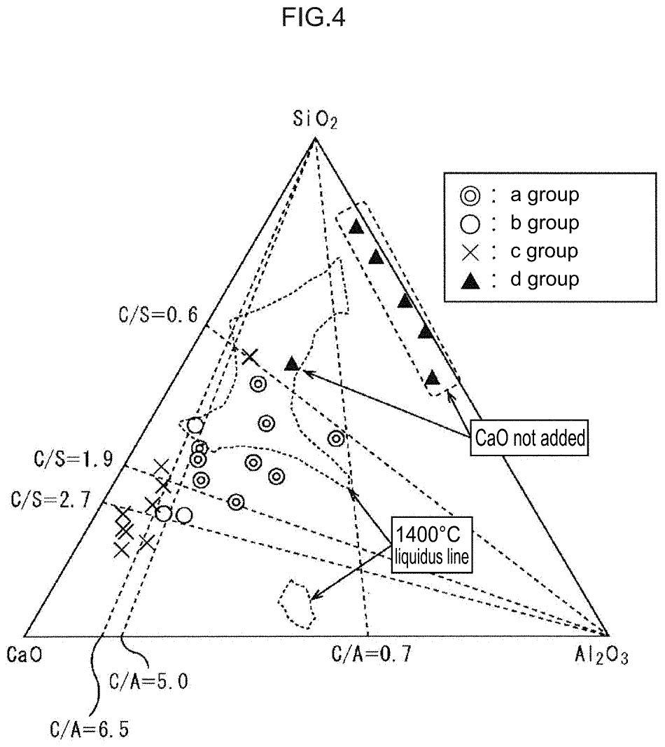

FIG. 4 is a diagram showing relationships between experimental results and a SiO₂—CaO-Al₂O₃ ternary phase diagram. In FIG. 4, a case in which the relative value K/K0 of the capacity coefficient exceeds 1.5 is the “a group”, a case in which the relative value K/K0 of the capacity coefficient is from more than 1.2 to 1.5 is the “b group”, and a case in which the relative value K/K0 of the capacity coefficient is 1.2 or lower is the “c group”. Further, the carbon material to which quicklime powder was not added shown in Table 1 was designated as the “d group”.

In FIG. 4, the liquidus line at 1400° C. is shown together with lines showing C/S=0.6, 1.9 and 2.7 and C/A=0.7, 5.0 and 6.5. As a result, the “b group” exists only in a region demarcated by C/S=0.6, C/S=2.7, C/A=0.7 and C/A=6.5, and the “a group” exists only in a region demarcated by C/S=0.6, C/S=1.9, C/A=0.7 and C/A=5.0. In cases in which any one of the ratio C/S or the ratio C/A was outside of the above-described regions, the relative value K/K0 of the capacity coefficient did not exceed 1.2.

The region of the ratio C/A for the “b group” and the “a group” was almost the same as the region in which the composition was present in a liquid phase at 1400° C. Further, the region of the ratio C/S for the “b group” and the “a group”, while partially overlapping with the region of the composition that was in a liquid phase at 1400° C., was displaced in terms of the region as a whole. In a region in which the ratio C/S was smaller than 0.6, viscosity was high even for the composition in a liquid phase at 1400° C., and it is presumed that removal of the ash film by agitation was not effectively accomplished. Further, in a region in which the ratio C/S was from 1.3 to 2.7, the composition was not in a liquid phase; however, it is presumed that CaO is saturated and desulfurization near the interface occurs in the reduction field formed by the carbon material, resulting in an improvement in the carburization rate.

In fact, it is shown that increases in the S concentration in molten iron tend to be further suppressed the higher the ratio C/S becomes. In addition, due to the excessive presence of CaO, sufficient contact opportunities between the exposed ash and the CaO accompanying the dissolution of the carbon content in the carbon material are secured, and it is also possible to presume an effect whereby the composition of the ash film becomes susceptible to change. However, in a region in which the ratio C/S was from higher than 1.9 to 2.7, there is much solid and unreacted quicklime, and this unreacted quicklime inhibits contact between molten iron and the carbon material, and for this reason, it is thought that the carburization rate is lower than in a region in which the ratio C/S is 1.9 or lower. Further, in a case in which the ratio C/S exceeds 2.7, the contact inhibition effect due to the quicklime powder is strengthened and compared with a case in which quicklime powder is not added, the carburization rate did not improve, and in some cases, the carburization rate decreased.

From the foregoing experimentation, with the carburizer of the present disclosure, it is understood to be important that the conditions 0.6≤C/S≤2.7 and 0.7≤C/A≤6.5 are satisfied, within which ranges the carburization rate improves, and in addition, in a range in which the conditions 0.6≤C/S≤1.9 and 0.7≤C/A≤5.0 are satisfied, the effect of improvement of the carburization rate is particularly large.

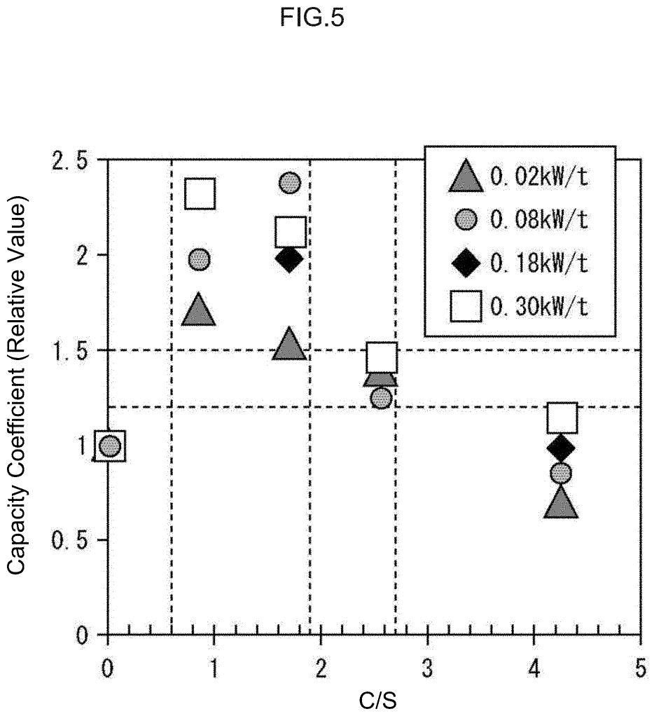

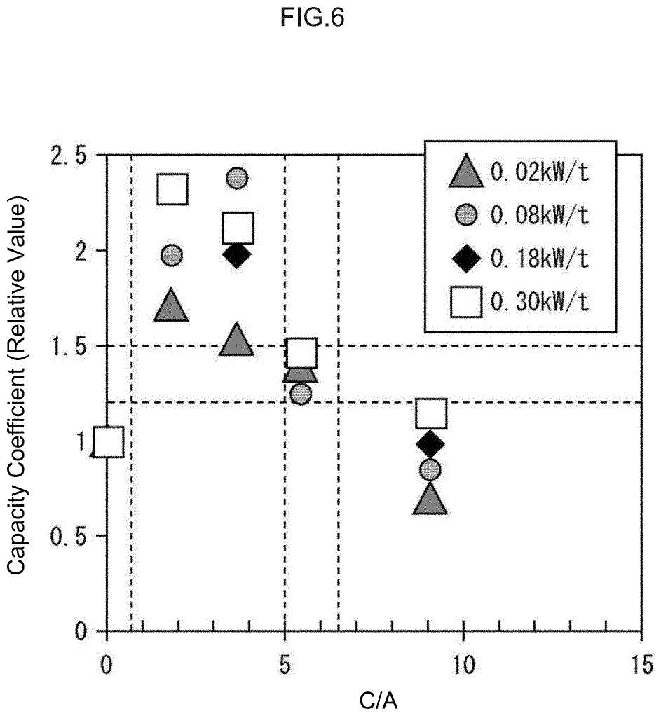

Next, the results of changing the agitation power density for coal A in the same small furnace are shown in FIGS. 5 and 6. As shown in FIGS. 5 and 6, an increase in the carburization rate was confirmed in the same C/S region and the same C/A region as in the case of ∈=0.08 kW/t for each of the agitation intensities ∈=0.02, 0.18 and 0.30 kW/t. From the foregoing results, when 0.6≤C/S≤2.7 and 0.7≤C/A≤6.5 are satisfied, and preferably, when 0.6≤C/S≤1.9 and 0.7≤C/A≤5.0 are satisfied, the effect of improving the carburization rate was obtained regardless of the level of the agitation intensity.

The ratio R of quicklime contained in the carburizer when the above-described conditions for the ratio C/S and the ratio C/A are satisfied can be calculated by the following procedure. The total of the mass of SiO₂ (ms) in the ash and the mass of Al₂O₃ (ma) in the ash does not exceed the amount of ash in the carbon material contained in the carburizer. Therefore, if the ratio of quicklime in the carburizer is R (=Mc/M) and the ratio of ash in the carbon material is (ASH), the following Formula (5) is established.

ms+ma≤Mx(1−R)×(ASH) Formula (5):

Further, by multiplying both sides of Formula (5) by C/(ms+ma) and using the relationship R≤C, the following Formula (6) is obtained.

RD≤C≤(1−R)×(ASH)/{1/(C/S)+1/(C/A)} Formula (6):

Here, the variable X is defined by the following Formula (7).

X=(ASH)/{1/(C/S)+1/(C/A)} Formula (7):

In this case, X will monotonically increase with respect to each of (ASH), the ratio C/S, and the ratio C/A.

By transforming Formula (6) and substituting Formula (7) therein, the following Formula (8) is obtained.

R≤1/(1+1/X) Formula (8):

Here, since the right side of Formula (8) increases monotonically with respect to X, the larger the ash ratio (ASH), the ratio C/S, and the ratio C/A, the larger the upper limit of the quicklime ratio R. When the preferred ranges of the ratio C/S and the ratio C/A discussed above are substituted in, the maximum of the ratio R of quicklime in the carburizer becomes approximately 19.9%.

As described above, the content of quicklime can be suppressed as compared with conventional cases. Although there is an increase in cost due to the use of a mixing device for the carbon material and the quicklime, in addition to the cost reduction due to the high carburization rate, there is also a cost reduction effect that occurs as a result, for example, of reduced clogging in the pipe due to the hygroscopic effect of quicklime. As a result, operating costs as a whole are greatly reduced, the use of low-grade carbon material can be promoted, and the cost of the carburizer can be significantly reduced.

Although a mixed powder was used as the carburizer in these experiments, the carburizer may be obtained through an ingot casting process such as briquetting. When briquetting is performed, the carbon material and the quicklime, which is an additive, are brought closer to each other, whereby the removal effect due to modification of the ash film is increased.

Further, if the carburizer can be fed in by free fall from above the furnace, equipment related to gas transfer can be omitted, and further, restrictions on the particle size and the like of the carburizer are relaxed, and costs are reduced. Taking this into consideration, the maximum particle size of the carbon material as the carburizer is preferably 20 mm or less in order to secure the contact area with the molten iron and secure the carburization rate. However, when using coal containing 10% or more of volatile matter as the carbon material, for example, since the volatile content is volatilized and pulverized by heating before contact with molten iron, not only coal having a maximum particle size of 20 mm or less but also coal having a maximum particle size of 100 mm or less can be used. Further, when adding a carbon material from above, since the carbon material will not reach the molten iron if the particle size is too small and will be discharged from the furnace together with exhaust gas and thus lost, the lower limit of the maximum particle size of the carbon material is preferably 0.2 mm.

Further, when there is a large amount of ash in the carbon material, even if the ash film is modified by incorporating quicklime, there is a possibility that the amount of ash film will become too large and will not be effectively removed from the interface. Therefore, the upper limit of the ash content in the carbon material is 18% by mass. Further, the smaller the ash content in the carbon material, the less effective it becomes to incorporate quicklime, and further, carbon material having a lower ash content is expensive. In consideration of cost, the lower limit of the ash content in the carbon material is 5% by mass.

The additive to be mixed with the carbon material is quicklime in which the main component is CaO. Even if a substance, in which CaCO₃ such as limestone is the main component, is used as an additive, since, when added to the furnace and heated, CO₂ is eliminated to become CaO, in principle, the same effect as with quicklime is expected; however, in practice, the expected effect is not obtained. The reason for this is that the CO₂ elimination reaction is an endothermic reaction, and it is thought that since the carburizing reaction is also an endothermic reaction, heat is not sufficiently applied to the ash film and the fluidity of the ash film remains insufficient, whereby the ash film is not effectively removed.

The CaO content in quicklime mixed with the carbon material is preferably 80% by mass or more, and more preferably 90% by mass or more.

The maximum particle size of the quicklime to be added is preferably 10 mm or less in order to uniformly disperse the quicklime on the surface of the carbon material and obtain its effect. Further, more preferably, the quicklime is in powder form, and the maximum particle size is 1 mm or less.

Next, a carburization method using the above-described carburizer is described. In the example shown in FIG. 1, an AC electric furnace is used; however, the furnace is not limited to the AC electric furnace shown in FIG. 1 as long as it has both of the features that the carburizer is supplied from above the molten iron surface and that agitation by gas is possible. In this embodiment, an AC electric furnace, a DC electric furnace, or a ladle is envisaged as a smelting container for performing carburization under conditions in which the agitation strength is weak. It is not envisaged that carburization will be performed under strong agitation conditions using a converter-type refining facility.

In principle, quicklime is mixed with the carburizer to modify the ash film, and when the molten slag comes into contact with the carburizer, the effect of incorporating quicklime is reduced. Therefore, if a molten slag layer is present on the molten iron, it is preferable that bottom-blown gas is blown from a bottom-blown tuyere, the molten iron is agitated to locally expose the molten iron surface, and the carburizer is fed in so as to directly contact the molten iron surface. The type of bottom-blown gas is not limited, and injection may be used instead of bottom-blowing as the gas agitation method. A solid component may be present in the molten slag layer.

Further, in the example shown in FIG. 1, the carburizer is supplied together with the gas conveyed from the lance 3; however, the carburizer may be supplied from plural lances or the carburizer may be supplied by free fall. Further, a cold iron source may be present that remains unmolten when the carburizer is supplied. Further, the S concentration of the molten iron that is the carburization target is preferably 0.5 mass % or less from the viewpoint of operability when removing S.

### Examples

Next, examples performed for confirming the action and effect of the carburizer of the present disclosure will be described. The data shown in these examples are merely examples of cases in which the present disclosure is applied, and the scope of application of the present disclosure is not limited thereto.

Iron scrap was melted by arc heating from a graphite electrode (electrode 2) using an actual arc-type bottom-blown electric furnace (electric furnace 1) capable of melting 90 tons of molten iron as shown in FIG. 1. In addition, N₂ gas was blown in from bottom-blown tuyere 4 and the molten iron was agitated and the temperature of the molten iron was measured. The bottom-blown tuyere was provided in six locations, and the gas flow rate from each tuyere was adjusted so as to be uniform. Thereafter, the carburizer was supplied from above via the lance 3 by free fall, temperature measurement and sampling were performed at regular intervals while controlling the agitation intensity, and the molten iron temperature and the C concentration were measured, and the capacity coefficient K was calculated from the above-described Formula (3). The lance 3 was installed directly above one of the bottom-blown tuyeres 4, the surface of the molten iron was exposed by agitation by the bottom-blown gas, and the carburizer was added to the exposed portion. The agitation power density at this time was ε=0.18 kW/t. In addition, arc energization was implemented under certain conditions during carburization. The carburizer is a mixture of a carbon material having a maximum particle size of 20 mm and quicklime powder having a maximum particle size of 1 mm (CaO content in quicklime: 90% by mass). As the carbon material, coal A and coal C shown in Table 1 were used. Moreover, in the reference example, a carburizer was used that contained only a carbon material that was not mixed with quicklime powder. Table 2 shows the main operating conditions.

Regarding the “determination” in Table 2, compared with the reference example under the same conditions (same carbon type, same temperature) except that quicklime powder was incorporated, if the relative value K/K0 exceeded 1.0 when the capacity coefficient K0 of the compared reference example was 1.0, it is thought that the carburization rate was improved by the incorporation of quicklime powder. When the relative value K/K0 of the capacity coefficient K0 exceeded 1.2, it was determined that the carburization rate was significantly improved and Y (successful) was designated, and when it was 1.2 or lower, it was determined that no significant improvement was evident and N (unsuccessful) was designated, Specifically, Example 3 was compared with Reference Example 9, Example 4 was compared with Reference Example 8, and the remainder was compared with Reference Example 7.

TABLE 2

| | | | | | | | Arc | | | | | Determi- | |
|---|---|---|---|---|---|---|---|---|---|---|---|---|---|
| | | | Molten | Propor- | | | Ener- | | | | | nation | |
| | | | Iron | tion of | | | gization | Capacity | Capacity | | | Y: K/K0 > | |
| | | | Temper- | Quicklime | | | during | Coefficient | Coefficient K | | | 1.2 | |
| | | Carbon | ature | Powder | | | Carbu- | K | relative Value | | | N: K/K0 ≤ | Remarks regarding |
| | No. | Material | T(° C.) | [Mass %] | C/S | C/A | rization | [10⁻³/s] | (=K/K0) | | | 1.2 | Capacity Coefficient |
| Example | 1 | Coal A | 1500 | 4 | 0.72 | 1.54 | N | 1.9 | — | — | 1.58 | Y | Relative value is |
| | | | | | | | | | | | | | ratio relative to |
| | | | | | | | | | | | | | Reference Example 7 |
| | 2 | Coal A | 1500 | 8 | 1.49 | 3.18 | N | 2.4 | — | — | 2.00 | Y | Relative value is |
| | | | | | | | | | | | | | ratio relative to |
| | | | | | | | | | | | | | Reference Example 7 |
| | 3 | Coal A | 1600 | 8 | 1.49 | 3.18 | Y | 5.9 | 1.55 | — | — | Y | Relative value is |
| | | | | | | | | | | | | | ratio relative to |
| | | | | | | | | | | | | | Reference Example 9 |
| | 4 | Coal C | 1500 | 8 | 1.11 | 1.31 | N | 1.8 | — | 2.25 | — | Y | Relative value is |
| | | | | | | | | | | | | | ratio relative to |
| | | | | | | | | | | | | | Reference Example 8 |
| Compar- | 5 | Coal A | 1500 | 2 | 0.36 | 0.77 | N | 1.4 | — | — | 1.17 | N | Relative value is |
| ative | | | | | | | | | | | | | ratio relative to |
| Example | | | | | | | | | | | | | Reference Example 7 |
| | 6 | Coal A | 1500 | 16 | 3.25 | 6.93 | N | 0.5 | — | — | 0.42 | N | Relative value is |
| | | | | | | | | | | | | | ratio relative to |
| | | | | | | | | | | | | | Reference Example 7 |
| Reference | 7 | Coal A | 1500 | 0 | 0.01 | 0.03 | N | 1.2 | — | — | 1.00 | — | K0 with Coal A |
| Example | | | | | | | | | | | | | and without arc |
| | | | | | | | | | | | | | energization |
| | 8 | Coal C | 1500 | 0 | 0.08 | 0.99 | N | 0.8 | — | 1.00 | — | — | K0 with Coal C |
| | 9 | Coal A | 1600 | 0 | 0.01 | 0.03 | Y | 3.8 | 1.00 | — | — | — | K0 with Coal A |
| | | | | | | | | | | | | | and with arc |
| | | | | | | | | | | | | | energization |

In each of Examples 1 to 4 shown in Table 2, conditions were such that the ratio C/S and the ratio C/A respectively satisfied ranges of 0.6 to 2.7 and 0.7 to 6.5. In these cases, the relative values of the capacity coefficients were all Y, which were favorable results. Comparing Example 4 and Reference Example 8, even when coal C having high ASH is used, by using a carburizer mixed with quicklime powder at an appropriate ratio, it was shown that a significant increase in carburization rate can be achieved over coal A, which has lower ASH and lower volatile content than coal C. Example 3 had the condition that the molten iron temperature was 1600° C.; however, a significant increase in the carburization rate by mixing quicklime powder with the carburizer, similarly to the condition of 1500° C., was confirmed.

In Comparative Example 5, the ratio C/A was in the range of 0.6 to 2.7, but the ratio C/S was outside of the range of 0.7 to 6.5. In this case, the relative value of the capacity coefficient was 1.17 even when compared with Reference Example 7, and no significant increase in the carburization rate was observed.

Further, in Comparative Example 6, both of the ratio C/S and the ratio C/A were outside of the above ranges (C/S: 0.6 to 2.7; C/A: 0.7 to 6.5). In this case, the relative value of the capacity coefficient was 0.42 as compared with Reference Example 7, and the carburization rate decreased.

As described above, in the examples of the present disclosure, it was confirmed that the carburization rate can be promoted even by using a carbon material having high ASH and poor solubility.

Although the present disclosure has been described above with reference to embodiments, the present disclosure is not limited to the configuration described in the foregoing embodiments, and also includes other embodiments and variations that may be considered to be within the scope of the features recited in the patent claims.

### EXPLANATION OF REFERENCE NUMERALS

| | |
|---|---|
| 1 | Electric furnace |
| 2 | Electrode |
| 3 | Lance |
| 4 | Bottom-blown tuyere |
| 5 | Molten iron |

The disclosure of Japanese Patent Application No. 2018-230108, filed on Dec. 7, 2018, is incorporated herein by reference in its entirety. All documents, patent applications, and technical standards described herein are incorporated by reference herein to the same extent as if the individual documents, patent applications, and technical standards were specifically and individually described.

1. A carburizer that effects carburization with respect to molten iron accommodated in an electric furnace or a ladle, the carburizer comprising a mixture of quicklime and a carbon material having an ash content of from 5 mass % to 18 mass %, and the carburizer satisfying conditions stipulated in the following Formula (1) and Formula (2):
0.6≤(mc+Mc)/ms≤2.7 Formula (1):
0.7≤(mc+Mc)/ma≤6.5 Formula (2):
wherein, in Formula (1) and Formula (2), mc represents a mass of CaO in the carbon material, ms represents a mass of SiO₂ in the carbon material, ma represents a mass of Al₂O₃ in the carbon material, and Mc represents a mass of the quicklime.

2. The carburizer recited in claim 1, wherein the mixture satisfies conditions stipulated in the following Formula (1A) and Formula (2A):
0.6≤(mc+Mc)/ms≤1.9 Formula (1A):
0.7≤(mc+Mc)/ma≤5.0. Formula (2A):

3. A method of carburization using the carburizer recited in claim 1, the method comprising, in the electric furnace or the ladle, performing carburization by adding the carburizer to a molten iron surface formed by blowing in a gas and agitating the molten iron.

4. The method of carburization recited in claim 3, wherein the carburizer is added by being fed towards the molten iron surface from a lance.

5. A method of carburization using the carburizer recited in claim 2, the method comprising, in the electric furnace or the ladle, performing carburization by adding the carburizer to a molten iron surface formed by blowing in a gas and agitating the molten iron.

6. The method of carburization recited in claim 5, wherein the carburizer is added by being fed towards the molten iron surface from a lance.
